(19) United States
(12) Patent Application Publication
(10) Pub. No.: US 2026/0131895 A1
(43) Pub. Date: May 14, 2026

(54) BACK SUPPORT PAD WITH INTEGRATED STORAGE

(71) Applicant: Damian Derezinski, Elmwood Park, IL (US)

(72) Inventor: Damian Derezinski, Elmwood Park, IL (US)

(21) Appl. No.: 18/943,616

(22) Filed: Nov. 11, 2024

(51) Int. Cl. B64D 25/18; B32B 3/04; B32B 5/02; B32B 27/12; B32B 27/40; B64D 25/10

(52) U.S. Cl. CPC B64D 25/18; B32B 3/04; B32B 5/02; B32B 27/12; B32B 27/40; B64D 25/10; B32B 2262/0269; B32B 2307/581; B32B 2307/714; B32B 2605/18

(57) ABSTRACT

Systems and devices for a back support pad with integrated storage include a pack including an exterior, an interior, a flotation system, and one or more drainage grommets. The exterior includes at least one penetration resistant surface and at least one cushion surface opposite the penetration resistant surface. The interior includes an anti-corrosive rigid layer and a cushion layer, where the anti-corrosive rigid layer at least partially encases the cushion layer and the cushion layer includes a cavity. The flotation system includes an inflation component located in the cavity and an inflatable device coupled to the inflation component, where the inflation component and the inflatable device at least partially separated by the anti-corrosive rigid layer. The drainage grommet(s) may be located at a bottom surface of the pack fluidly connecting the interior and the exterior, where the drainage grommet arranged to provide fluid flow between the interior and the exterior.

### BACKGROUND

The present disclosure relates generally to a pack. More specifically, the present disclosure relates to a pack that includes safety features including a penetration resistant external surface, floatation device, and firearm storage, all of which can provide safety to a user. The pack can be attached to an airplane seat.

Some airplanes have ejector seats. When deployed, the user situated in the ejector seat may be ejected from the cabin of the airplane to an external environment above the ground. As the user descends to the ground, the user may deploy a parachute, which slows the user's descent. However, during the slowed descent, the user may be exposed to potentially dangerous conditions without any means to defend themselves.

Therefore, there is a need for a survival kit in the form of a pack that includes a penetration resistant exterior surface, an anti-corrosive interior for storage, drainage grommets, and a flotation device. In some contexts, such as the one described above, there is a need for a survival kit in the form of a pack that includes a penetration resistant exterior surface, an anti-corrosive interior for storage, drainage grommets, and a flotation device, where the pack is attached to an airplane seat.

### SUMMARY

One exemplary embodiment of the present disclosure relates to a pack. The pack includes an exterior which includes at least one penetration resistant surface and at least one cushion surface opposite the penetration resistant surface. The pack also includes an interior which includes an anti-corrosive rigid layer and a cushion layer. The anti-corrosive rigid layer at least partially encases the cushion layer. The cushion layer of the interior includes a cavity. The pack also includes a flotation system. The flotation system includes an inflation component and an inflatable device. The inflation component is located in the cavity. The inflation component and the inflatable device are at least partially separated by the anti-corrosive rigid layer. The pack also includes a drainage grommet at a bottom surface of the pack. The drainage grommet fluidly connects the interior and the exterior. The drainage grommet is arranged to provide fluid flow between the interior and the exterior.

In some embodiments, the pack includes a manual activation mechanism for the flotation system. The manual activation mechanism may be configured to be triggered to inflate the inflation component of the pack. In some embodiments, the pack is configured so that the inflation component at least partially exits the pack interior upon inflation of the inflation component. The inflation component of the inflation system may be a CO₂ cartridge.

In some embodiments, the exterior is water resistant. In some embodiments, the cushion surface and cushion layer are made of the same material. The cushion surface and cushion layer may be made of polyurethane. The cushion layer may be made of multiple segments. In some embodiments, the penetration resistant surface and the anti-corrosive rigid layer are made of different materials. The penetration resistant surface may be made of at least one of an aramid fiber or a hard plate. The anti-corrosive rigid layer may be made of at least one of stainless steel, aluminum, carbon steel, brass, alloy steel, polypropylene, duplex stainless steel, martensitic stainless steel, aluminum alloy, carbon fiber, copper, or nickel.

In some embodiments, the pack includes securing means attached to the cushion layer. The securing means may be configured to secure an external component inside the cavity. The securing means may be selected from at least one of hook and loop fasteners, hooks, or a pouch. In some embodiments, the pack includes an opening mechanism on a surface of the exterior. The opening mechanism may be a zipper. In some embodiments, the pack includes a cutting tool removably attached to the exterior.

Another exemplary embodiment of the present disclosure relates to an airplane seat. The airplane seat includes a seat body. The seat body includes a seat back and a seat bottom. The airplane seat also includes a pack attached to the seat back. The pack includes an exterior which includes at least one penetration resistant surface and at least one cushion surface opposite the penetration resistant surface. The pack also includes an interior which includes an anti-corrosive rigid layer and a cushion layer. The anti-corrosive rigid layer at least partially encases the cushion layer. The cushion layer of the interior includes a cavity. The pack also includes a flotation system. The flotation system includes an inflation component and an inflatable device. The inflation component is located in the cavity. The inflation component and the inflatable device are at least partially separated by the anti-corrosive rigid layer. The pack also includes a drainage grommet at a bottom surface of the pack. The drainage grommet fluidly connects the interior and the exterior. The drainage grommet is arranged to provide fluid flow between the interior and the exterior.

In some embodiments, the airplane seat includes a parachute. In some embodiments the pack is removably attached to the airplane seat. In some embodiments the pack exterior includes an opening mechanism. In some embodiments the opening mechanism on the pack exterior is configured to be accessed while a user is in the airplane seat.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 shows a front, perspective view of the pack according to an illustrative embodiment, with a cutout showing the interior cushion layer with cavity.

FIG. 2 shows a top plan view of the pack shown in FIG. 1, according to an illustrative embodiment.

FIG. 3 shows a bottom plan view of the pack shown in FIG. 1, according to an illustrative embodiment.

FIG. 4 shows a back plan view of the pack shown in FIG. 1, according to an illustrative embodiment.

FIGS. 5 and 6 show example views of the interior of the pack shown in FIG. 1, according to an illustrative embodiment.

FIG. 7 is a schematic showing a side view configuration of the pack exterior and interior, according to an illustrative embodiment.

FIGS. 8 and 9 show perspective views of the airline seat, according to an illustrative embodiment.

### DETAILED DESCRIPTION

The present disclosure generally relates to survival kits. More particularly, the present disclosure relates to an assembly with various features including an anti-corrosive, cushioned interior, flotation system, and drainage grommets, the combination of which can provide protection to both a user and to components stored within the assembly. In one exemplary embodiment, the assembly is a standalone pack. In another exemplary embodiment, the assembly is a pack incorporated into an airplane seat, either permanently or removably.

Before turning to the FIGURES, which illustrate certain exemplary embodiments in detail, it should be understood that the present disclosure is not limited to the details set forth in the description or illustrated in the FIGURES. It should also be understood that the terminology used herein is for the purpose of description only and should not be regarded as limiting.

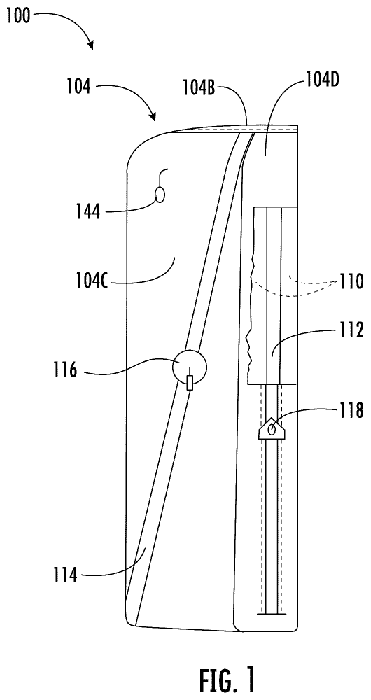

Referring generally to FIGS. 1-7, disclosed herein is a pack depicted according to a first exemplary embodiment. Each of FIGS. 1-7 show the first exemplary embodiment from different views. Each feature of the pack is described in further detail below. The pack includes an exterior, which includes at least one penetration resistant surface and one cushion surface. The pack also includes an interior, which includes an anti-corrosive rigid layer and a cushion layer. The exterior can be defined by a top surface, a bottom surface, and lateral surfaces. At least one lateral surface is made of penetration resistant material, and at least one lateral surface is made of cushion material. The pack further includes drainage grommets and a flotation system.

According to the exemplary embodiments, the penetration resistant surface is made of poly-paraphenylene terephthalamide, the anti-corrosive layer is made of carbon fiber, and the cushion surface and cushion layer are both made of polyurethane.

FIG. 1 illustrates a front, perspective view of a pack 100. The pack 100 includes an interior 102 and exterior 104. The interior 102 can be fully encased within the exterior 104. The interior 102 is at least partially hollow and includes a cushion layer 108 (not shown in FIG. 1) and an anti-corrosive rigid layer 110. The cushion layer can include a cavity. The cavity can include a cavity opening 112. The cavity can be used for storage, and the cavity opening 112 can be used by a user to easily access the contents of the interior.

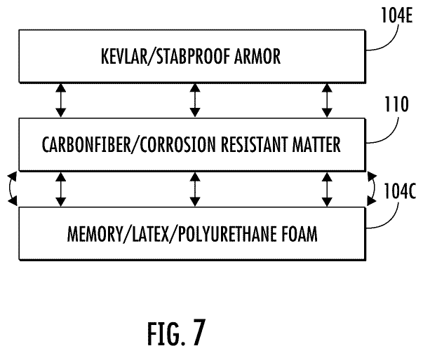

Referring now to the embodiment of FIGS. 1-4, the exterior 104 has a top surface 104A, a bottom surface 104B, a first lateral surface 104C, a second lateral surface 104D and third lateral surface 104E, and a fourth lateral surface (not shown in the figures). According to the embodiment of FIG. 7, the lateral surfaces can be of non-uniform thickness. In other embodiments, the lateral surfaces are a uniform thickness. According to the exemplary embodiment, the exterior can have a substantially rectangular parallelepiped shape. In other embodiments, the exterior can have a shape similar to a backpack. In some embodiments the pack is similar in size to a backpack.

The exterior 104 includes at least one penetration resistant surface and at least one cushion surface opposite the penetration resistant surface. According to some embodiments, the exterior can include one cushion surface. According to some embodiments, the exterior can include one penetration resistant surface. In a preferred embodiment, the exterior includes one penetration resistant surface and five cushion surfaces. According to some embodiments, the exterior may be water resistant. The surfaces of the exterior may incorporate a water-resistant material. Alternatively, a water-resistant covering may be used to surround the exterior surfaces. In one embodiment, the water-resistant material can be nylon.

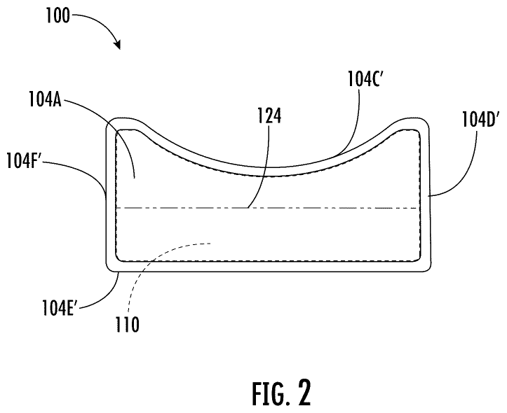

Referring still to the embodiment of FIGS. 1-4, the first lateral surface 104C is the cushion surface, opposite the third lateral surface 104E which is the penetration resistant surface. The cushion surface can provide comfort to a user wearing the pack. As shown in the embodiment of FIG. 2, first lateral surface 104C is curved to fit the back of the user (e.g., the first lateral surface 104C may be concave, or complementary to a back of a user), which provides comfort for the user of the pack. In other embodiments, the first lateral surface is not curved. The cushion surface can be made of a cushion material such as polyurethane, latex, silicone, or similar material. In some embodiments, the cushion surface is made of multiple cushion materials. The penetration resistant surface can be made of a rigid material or a flexible material. In some embodiments, the penetration resistant surface is made of a combination of rigid and/or flexible materials. The rigid material for the penetration resistant surface can include metal, plastic, or ceramic. The flexible material for the penetration resistant surface can include a synthetic fiber such as an aramid fiber. More specifically, the penetration resistant material can be a para-aramid fiber. In the exemplary embodiment, the penetration resistant material is made of the para-aramid fiber poly-paraphenylene terephthalamide (e.g., KEVLAR®). In one embodiments, the penetration resistant material is resistant to bullets. In other embodiments the penetration resistant material is resistant to blades, or any other device capable of penetrating a material. In one embodiment the penetration resistant material is resistant to both bullets and blades.

Referring specifically to FIG. 1, restraining means 114 may be attached to the exterior 104 of the pack 100. Restraining means may be used to attach the pack to a user. According to the embodiment of FIG. 1, restraining means 114 are attached to the first lateral surface 104C. In other embodiments, restraining means can be attached to other surfaces of the exterior. The user can wear the pack 100 using restraining means 114 such that the first lateral surface 104C is adjacent to the back of the user. According to the embodiment of FIG. 1, the restraining means 114 is a strap. However, in some embodiments, the securing means can be, for example, a harness, zipper, buckle. In one embodiment, the restraining means can be a single strap. In an alternative embodiment, the restraining means may include two straps to secure the pack to the user. The straps can be configured to run across the body of a user. According to the embodiment of FIG. 1, restraining means 114 includes release 116, which a user may use to rapidly disengage from pack 100. The release can be a buckle, button, pull cord. The restraining means can be adjustable to a user's preference.

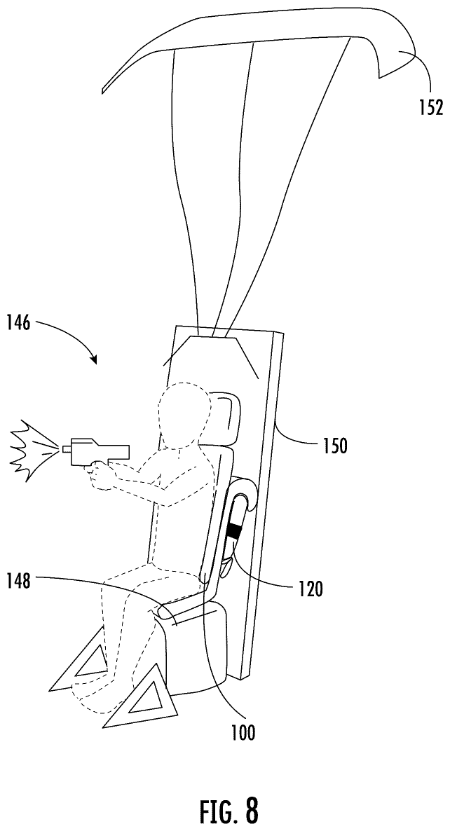

The exterior 104 may include openings so that a user can access the interior. The openings can be permanently open or temporarily opened using opening mechanisms fixed to the pack exterior. As shown in the embodiment of FIG. 1, interior 102 can be accessed by opening mechanism 118. If a user does not want to access the contents of the pack, the opening mechanism can be in a closed position. Opening mechanism 118 may be on the second lateral surface 104D. In FIG. 1, opening mechanism 118 is in a partially open position, so that the cavity opening 112 is visible. Dashed lines indicate the location of the anti-corrosive rigid layer 110 which is underneath the exterior. In other embodiments, the opening mechanism can be on other surfaces of the exterior. In some embodiments, there can be multiple opening mechanisms on the pack exterior. As shown in the embodiment of FIG. 1, opening mechanism 118 may be a zipper. However, in other embodiments, the opening mechanism can be for example a hook-and loop fastener, snap, button, or pull-cord. In another embodiment, the pack interior can be accessed using a cutting tool. According to the embodiment in FIG. 8, a user can use a cutting tool 120, such as a blade, to cut the pack open. In this way, the user can access the contents of the interior. The cutting tool can be used by the user to cut the exterior open to access the interior. In one embodiment, the cutting tool is removably attached to a lateral surface of the exterior. In some embodiments, there is more than one cutting tool. In some embodiments, there is both an opening mechanism and cutting tool.

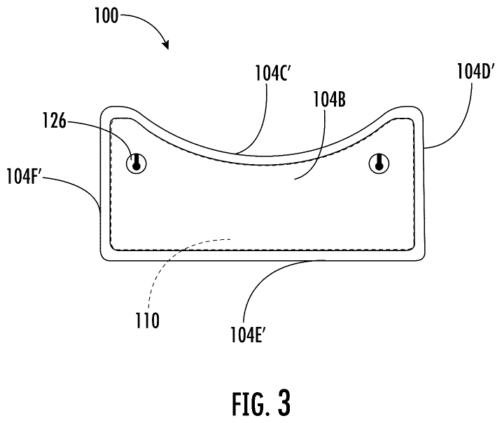

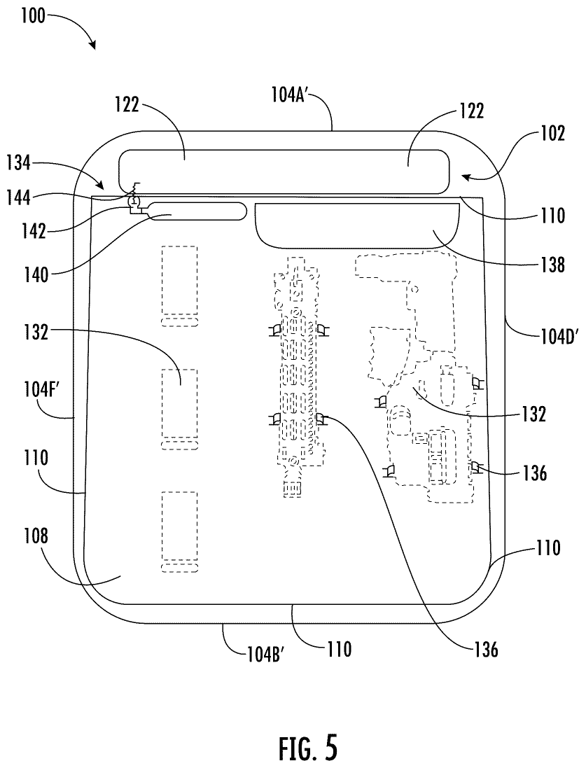

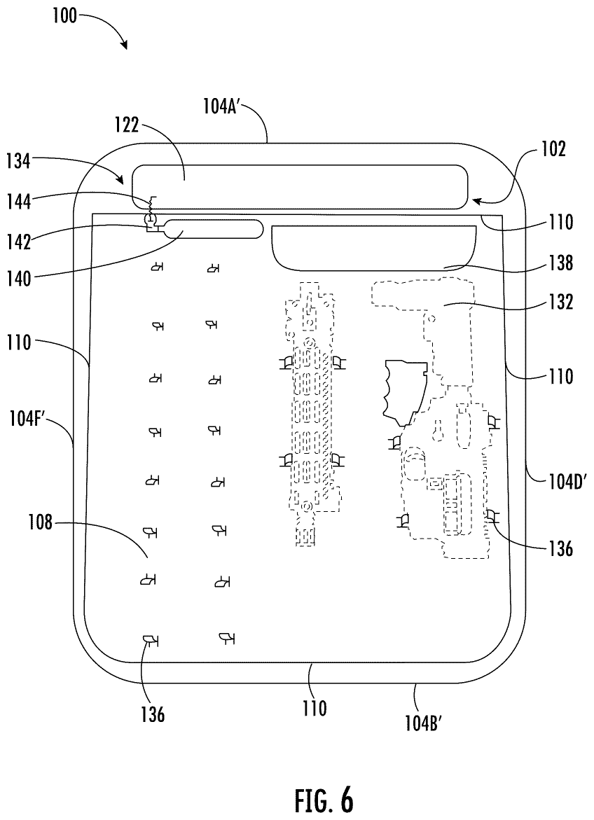

FIG. 2 is a top view of pack 100, showing top surface 104A and the top edges of the four lateral surfaces of the exterior 104. The top edge of the first lateral surface 104C is represented by 104C′, the top edge of the second lateral surface 104D is represented by 104D′, the top edge of the third lateral surface 104E is represented by 104E′, and the top edge of the fourth lateral surface is represented by 104F′. Hidden lines also show the outline of the anti-corrosive rigid layer 110 of the interior 102. According to the embodiment of FIGS. 2-3, the anti-corrosive rigid layer 110 is the same approximate shape as the exterior 104. Top surface 104A can be configured so that an inflatable device 122 (shown in FIGS. 5-6) can emerge out of the top of the exterior once inflated. According to the embodiment of FIG. 2, top surface 104A is configured with loose stitching 124 across a width of the surface. In some embodiments, the inflatable device only partially emerges out of the top of the exterior. Alternative embodiments can include a flap or a slit on the top surface for the inflatable device to emerge. In some embodiments, other surfaces of the exterior can be configured so that an inflation component can emerge therefrom. In some embodiments, the inflatable device remains in the interior once inflated. The inflation component is described in greater detail later on in this section.

FIG. 3 is a bottom view of pack 100 showing bottom surface 104B and the bottom edges of the four lateral surfaces of the exterior 104. Hidden lines also show an anti-corrosive rigid layer 110 of the interior. Bottom surface 104B includes drainage grommets 126, which are configured to fluidly connect the interior 102 and the exterior 104. The drainage grommets allow for the passage of fluid to flow from the interior 102 to the exterior 104, in the event there is liquid in the interior 102 of the pack 100. In one embodiment, there are at least two drainage grommets 126 (though any number of drainage grommets 126 may be included or incorporated into the pack 100). For example, and in some embodiments, there may be only one drainage grommet 126 which fluidly connects the interior and exterior. In some embodiments, additional drainage grommets 126 may run along the bottom surface 104B (and/or through other surfaces) of the exterior to fluidly connect the interior and the exterior. In some embodiments, the drainage grommets 126 can be made of metal or plastic.

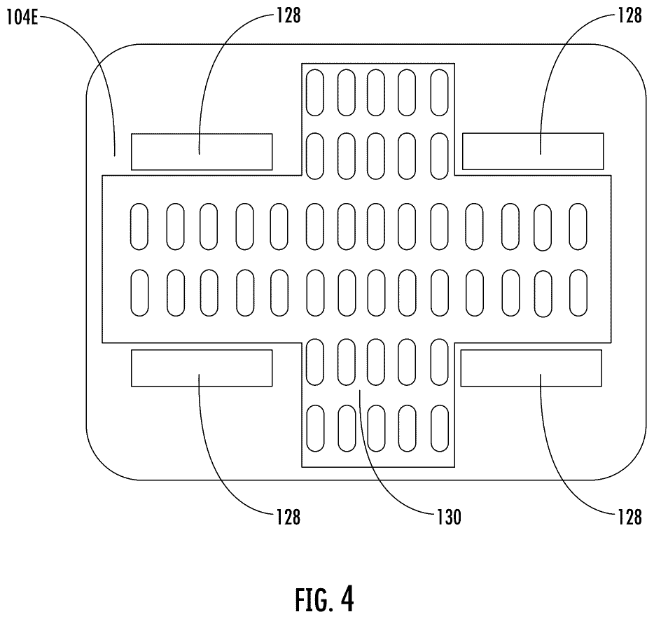

FIG. 4 is a back view of pack 100, showing the third lateral surface 104E. According to the embodiment of FIGS. 1-4, the third lateral surface 104E is penetration resistant. Third lateral surface 104E can include attachment means 128, which can be used to removably attach the pack 100 to an external surface. In one embodiment, the attachment means are hook and loop fasteners, however other attachment means may include buckles and/or snaps. The external surface can include, but are not limited to an airplane seat, submarine seat, automobile seat, or wall. The third lateral surface 104E can also include a pocket 130, which can be used for storage. In one embodiment, there is one pocket for storage. In other embodiments there are multiple pockets for storage.

FIGS. 5-6 are views of the interior 102 of the pack 100, showing the contents of the interior including external attachments 132 and a flotation system 134. The pack exterior is indicated by the edge 104A′ of top surface 104A, the edge 104B′ of bottom surface 104B, and edges 104D′ and 104F′. The interior 102 includes a cushion layer 108 and the anti-corrosive rigid layer 110. In one embodiment, the interior is removably attached to the exterior. In other embodiments the interior is fixed to the exterior. The cushion layer includes a cavity. As seen in the embodiment of FIG. 1, the cushion layer 108 can be configured to include a cavity opening 112, which opens to the cavity of the interior. In one embodiment, the cushion layer includes one segment, which includes a hollow cavity in the interior. In other embodiments, the cushion layer includes multiple segments which can be joined together to form the cavity. The anti-corrosive rigid layer at least partially encases the cushion layer. In the views of the interior shown in FIGS. 5-6, the anti-corrosive rigid layer 110 fully surrounds the cushion layer 108 at select depths, however according the exemplary embodiment, the anti-corrosive rigid layer does not fully encase the cushion layer, and the cushion layer includes a cavity opening 112. The cavity of the interior can be used to store external components.

The external components can be secured in the interior using securing means. In some embodiments, there may be multiple sizes and shapes of securing means. In some embodiments there may be multiple types of securing means. In some embodiments, the securing means can be selected from hook and loop fasteners, hooks, or a pouch attached to the cushion layer. In other embodiments, the securing means may be cutouts in the cushion layer. The securing means according to the embodiment of FIGS. 5 and 6 are hooks 136 and a pouch 138. In FIGS. 5-6, hooks 136 and pouch 138 are on the cushion layer. The securing means can be adapted in size and placement to accommodate external components of varying dimensions. In a one embodiment, the external components can be firearms, or parts/components of firearms, or attachments for firearms, or ammunition. In other embodiments, the external components can be a blade, a first aid kit, food, flares, or other survival tools. According to the embodiment of FIGS. 5-6, the external attachments 132 are firearms and ammunition.

The cushion layer is made of a cushion material. The cushion material may be polyurethane, latex, or silicone, or similar material. In some embodiments, the cushion layer can be made of multiple types of cushion material. In some embodiments, the cushion layer and cushion surface of the exterior can be made of different materials. In other embodiments, the cushion layer and the cushion surface of the exterior can be made of the same material. The anti-corrosive rigid layer can be made of an anti-corrosive material such as stainless steel, aluminum, carbon steel, brass, alloy steel, polypropylene, duplex stainless steel, martensitic stainless steel, aluminum alloy, carbon fiber, copper, or nickel. In some embodiments, the anti-corrosive rigid later can be made of multiple types of anti-corrosive material. In some embodiments, the anti-corrosive rigid layer and penetration resistant surface can be made of different materials. In other embodiments, the anti-corrosive rigid layer and penetration-resistant surface on the exterior can be made of the same materials.

Referring now to FIGS. 5-6, the pack 100 includes flotation system 134, which can include an inflation component 140, coupling means 142, and an inflatable device 122. In one embodiment, the coupling means couples the inflation component to the inflatable device, so that the inflation component can inflate the inflatable device. In another embodiment, the inflation component is directly coupled to the inflatable device. In one embodiment, the coupling means is a valve. According to the embodiment of FIGS. 5-6, the inflatable device 122 is housed in the interior 102 in an uninflated state. When inflated, the inflatable device emerges through the exterior to be situated on the outside of the pack (not shown in the figures).

Referring now still to FIGS. 5-6, the inflatable device 122 is stored under the top surface 104A of the exterior and the inflation component 140 is located in the cavity of the interior 102. The inflation component can be secured in the cavity using securing means. Further, the inflation component and the inflatable device can be at least partially separated by the anti-corrosive layer. In FIGS. 5 and 6, the coupling means 142 runs through the anti-corrosive rigid layer 110, so that the inflation component 140 and inflatable device 122 are fully separated by the anti-corrosive layer. In one embodiment, the inflation component can be a CO₂ cartridge. In other embodiments the inflation component can be for example a cartridge with a different type of gas. In one embodiment, the inflation component 140 can be manually activated by a manual activation mechanism 144. According to the exemplary embodiment shown in FIGS. 1, 5-6, the manual activation mechanism 144 is a pull-cord. In other embodiments, the activation mechanism can be for example a button or valve. With the manual activation mechanism, the user can activate the inflation component to inflate the inflatable device. In other embodiments, the inflation component can be automatically activated to inflate the inflatable device.

FIG. 7 shows schematic view of a side profile of pack 100 according to the exemplary embodiment. This schematic shows how the surfaces and layers of the interior and exterior are organized. The anti-corrosive rigid layer 110 is in between exterior lateral surfaces 104C and 104E. In some embodiments, the anti-corrosive rigid layer 110 is shorter than exterior lateral surfaces 104C and 104E. In this way the inflatable device in its uninflated state may be stored on the top of anti-corrosive rigid layer 110 under the top surface.

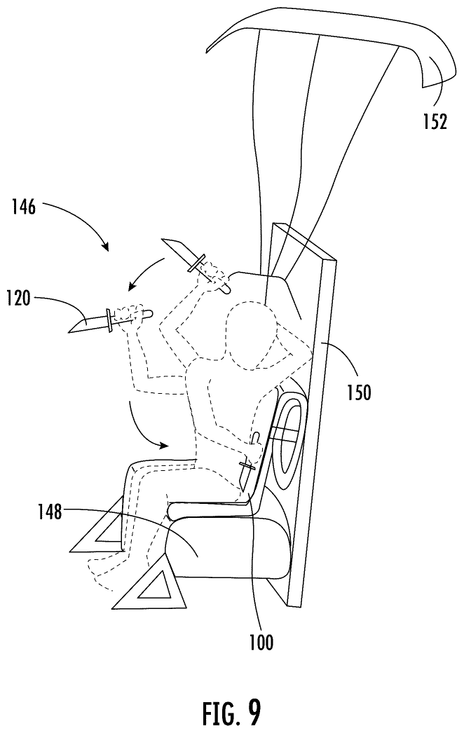

Referring now to FIGS. 8-9, disclosed herein is an airplane seat depicted according to an exemplary embodiment. FIG. 8-9 show perspective views of the airplane seat 146. In one embodiment, the airplane seat is an airplane seat suitable for commercial and private passenger aircrafts. In another embodiment, the airplane seat is an ejection seat, suitable for a military aircraft. The airplane seat 146 includes a seat bottom 148, seatback 150, and pack 100. The pack 100 may be attached to the seatback 150 of the airplane seat 146. In one embodiment, the pack can be removably attached to the seatback. The pack can be removably attached to the seatback using hook and loop fasteners, buckles, or straps. In another embodiment, the pack can be integrated into or permanently attached the seatback. The airplane seat 146 can further include a parachute 152.

The pack 100 of the airplane seat 146 includes an exterior, which includes at least one penetration resistant surface and at least one cushion surface opposite the penetration resistant surface. The pack also includes an interior, which includes an anti-corrosive rigid layer and a cushion layer. The cushion layer includes a cavity, in which external components can be stored. The penetration resistant material can be a rigid material or a flexible material, or a combination of rigid and/or flexible materials. The penetration resistant rigid material can include metal, plastic, or ceramic. The penetration resistant flexible material can include synthetic fiber such as an aramid fiber. The cushion surface and cushion layer can be made of a cushion material including polyurethane, latex, or silicone. The anti-corrosive rigid layer can be made of an anti-corrosive material including stainless steel, aluminum, carbon steel, brass, alloy steel, polypropylene, duplex stainless steel, martensitic stainless steel, aluminum alloy, carbon fiber, copper, or nickel.

The pack 100 of the airplane seat 146 further includes drainage grommets and a flotation system. The pack exterior of the airplane seat 146 also includes openings, so that a user can access the interior of the pack. These openings can be permanently open, or be temporarily opened using opening mechanisms fixed to the pack exterior. In one embodiment, the exterior can include an opening mechanism configured to be accessed by a user in the airplane seat. Preferably, the opening mechanism is configured so that a user in the airplane seat can access the opening mechanism while the parachute is deployed. The opening mechanism can be for example a zipper, hook and loop fastener, button, or snap. In some embodiments, there can be more than one opening mechanism on the exterior. In another embodiment the airplane seat can include a cutting tool, which a user can use to access the contents of the pack interior by cutting through the exterior. The cutting tool can be removably attached to the seat bottom, the seat back, or the pack exterior. According to the embodiment of FIGS. 8-9, cutting tool 120 is removably attached to the seatback 150, and while seated in the airplane seat 146 while the parachute 152 is deployed, the user can cut into pack 100. In some embodiments, the airplane seat can include both an opening mechanism and a cutting device. In some embodiments the pack include restraining means for attaching the pack to the user. Restraining means can be for example straps, harness, zipper, or buckle.

No claim element herein is to be construed under the provisions of 35 U.S.C. § 112(f), unless the element is expressly recited using the phrase “means for.”

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, and/or fluidic.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise.

It is important to note that the construction and arrangement of the components as shown in the various exemplary embodiments are illustrative only. Additionally, any component disclosed in an exemplary embodiment may be incorporated or utilized with any other embodiment disclosed herein. It should be appreciated that other elements of the various embodiments may be incorporated or utilized with any of the other embodiments disclosed herein.

What is claimed is:

1. A pack comprising:
an exterior comprising at least one penetration resistant surface and at least one cushion surface opposite the penetration resistant surface;
an interior comprising an anti-corrosive rigid layer and a cushion layer, the anti-corrosive rigid layer at least partially encasing the cushion layer, the cushion layer including a cavity;
a flotation system comprising an inflation component located in the cavity and an inflatable device coupled to the inflation component, the inflation component and the inflatable device at least partially separated by the anti-corrosive rigid layer; and
a drainage grommet at a bottom surface of the pack fluidly connecting the interior and the exterior, the drainage grommet arranged to provide fluid flow between the interior and the exterior.

2. The pack of claim 1, further comprising a manual activation mechanism for the flotation system, wherein the manual activation mechanism is configured to be triggered to inflate the inflation component.

3. The pack of claim 1, wherein the pack is configured for the inflation component to at least partially exit the exterior upon the inflation component inflating.

4. The pack of claim 1, wherein the cushion layer is comprised of multiple segments.

5. The pack of claim 1, further comprising securing means attached to the cushion layer, wherein the securing means are configured to secure an external component inside the cavity.

6. The pack of claim 4, wherein the securing means are selected from at least one of hook and loop fasteners, hooks, or a pouch.

7. The pack of claim 1, further comprising an opening mechanism on a surface of the exterior.

8. The pack of claim 1, wherein the opening mechanism is a zipper.

9. The pack of claim 1, further comprising a cutting tool removably attached to the exterior.

10. The pack of claim 1, wherein the exterior is water-resistant.

11. The pack of claim 1, wherein the cushion surface and cushion layer are comprised of the same material.

12. The pack of claim 1, wherein the penetration resistant surface and anti-corrosive rigid layer are comprised of different materials.

13. The pack of claim 1, wherein the penetration resistant surface is comprised of at least one of an aramid fiber or a hard plate.

14. The pack of claim 1, wherein the cushion layer is comprised of polyurethane.

15. The pack of claim 1, wherein the anti-corrosive rigid layer is comprised of at least one of stainless steel, aluminum, carbon steel, brass, alloy steel, polypropylene, duplex stainless steel, martensitic stainless steel, aluminum alloy, carbon fiber, copper, or nickel.

16. The pack of claim 1, wherein the inflation component comprises a CO₂ cartridge.

17. An airplane seat comprising:
a seat body comprising a seat back and a seat bottom;
a pack attached to the seat back, the pack comprising:
an exterior comprising at least one penetration resistant surface and at least one cushion surface opposite the penetration resistant surface;
an interior comprising an anti-corrosive rigid layer and a cushion layer, the anti-corrosive rigid layer at least partially encasing the cushion layer, the cushion layer including a cavity;
a flotation system comprising an inflation component located in the cavity and an inflatable device coupled to the inflation component, the inflation component and the inflatable device at least partially separated by the anti-corrosive rigid layer; and
a drainage grommet at a bottom surface of the pack fluidly connecting the interior and the exterior, the drainage grommet arranged to provide fluid flow between the interior and the exterior.

18. The airplane seat of claim 17, wherein the pack is removably attached to the seatback.

19. The airplane seat of claim 17, further comprising an opening mechanism on a lateral surface of the exterior, wherein the opening mechanism is configured to be accessed by a user in the airplane seat.

20. The airplane seat of claim 17, further comprising a parachute.
